(19) United States
(12) Patent Application Publication
(10) Pub. No.: US 2026/0196728 A1
(43) Pub. Date: Jul. 9, 2026

(54) ANTENNA, ANTENNA SYSTEM, AND VEHICLE

(71) Applicant: Shenzhen Yinwang Intelligent Technologies Co., Ltd., Shenzhen (CN)

(72) Inventors: Jianhua Lin, Dongguan (CN); Junhong Zhang, Dongguan (CN); Yi Fan, Shenzhen (CN); Zhiguo Huang, Dongguan (CN); Tongjie Li, Shenzhen (CN)

(73) Assignee: Shenzhen Yinwang Intelligent Technologies Co., Ltd., Shenzhen (CN)

(21) Appl. No.: 19/559,362

(22) Filed: Mar. 6, 2026

Related U.S. Application Data
(63) Continuation of application No. PCT/CN2024/105298, filed on Jul. 12, 2024.

(30) Foreign Application Priority Data
Sep. 8, 2023 (CN) 202311160190.9

(51) Int. Cl. H01Q 5/378; H01Q 7/00; H01Q 9/30

(52) U.S. Cl. CPC H01Q 5/378; H01Q 7/00; H01Q 9/30

(57) ABSTRACT

This disclosure provides an antenna, an antenna system, and a vehicle, and pertains to the field of wireless communication technologies. The antenna includes a main antenna, a parasitic antenna, and a mainboard, where the main antenna and the parasitic antenna are both located on a surface of the mainboard, and a plane on which the main antenna is located and a plane on which the parasitic antenna is located are parallel, and are opposite to each other. A feeding point of the main antenna is connected to a feeding transmission line of the mainboard, and the parasitic antenna is connected to a second ground end of the mainboard. A difference between a resonance frequency point of the main antenna and a resonance frequency point of the parasitic antenna is less than a target threshold.

### CROSS-REFERENCE TO RELATED APPLICATIONS

This application is a continuation of International Application No. PCT/CN2024/105298, filed on Jul. 12, 2024, which claims priority to Chinese Patent Application No. 202311160190.9, filed on Sep. 8, 2023. The disclosures of the aforementioned applications are hereby incorporated by reference in their entireties.

### TECHNICAL FIELD

This disclosure relates to the field of wireless communication technologies, and in particular, to an antenna, an antenna system, and a vehicle.

### BACKGROUND

With the rapid development of intelligent connectivity technologies and the advent of the fifth generation mobile communication technology (5th generation mobile network, 5G for short), it is possible to connect vehicles to a high-traffic, low-latency, and high-rate Internet of Everything network.

A vehicle-mounted antenna is a core component for implementing communication between the vehicle and the outside, and is usually disposed on the roof of the vehicle, for example, disposed in a luggage rack on the roof of the vehicle.

However, due to a limited height of the luggage rack, a size of the vehicle-mounted antenna is limited. Because a radiation frequency of the antenna is related to the size of the antenna, it is difficult for the vehicle-mounted antenna to implement 5G wideband coverage.

### SUMMARY

This disclosure provides an antenna, an antenna system, and a vehicle. The antenna is used in a vehicle, and can implement 5G wideband coverage. The technical solutions are as follows.

According to a first aspect, an antenna is provided, where the antenna includes a main antenna, a parasitic antenna, and a mainboard;
the main antenna and the parasitic antenna are both located on a surface of the mainboard, and a plane on which the main antenna is located and a plane on which the parasitic antenna is located are parallel, and are opposite to each other;
a feeding point of the main antenna is connected to a feeding transmission line of the mainboard, and the parasitic antenna is connected to a second ground end of the mainboard; and
a difference between a resonance frequency point of the main antenna and a resonance frequency point of the parasitic antenna is less than a target threshold.

In the solution shown in this disclosure, the difference between the resonance frequency point of the main antenna and the resonance frequency point of the parasitic antenna may be an absolute value of an absolute difference, and is specifically an absolute value of the difference between the resonance frequency point of the main antenna and the resonance frequency point of the parasitic antenna. For example, if the resonance frequency point of the main antenna is f1, and the resonance frequency point of the parasitic antenna is f2, the difference between the resonance frequency point of the main antenna and the resonance frequency point of the parasitic antenna is |f1−f2|.

Alternatively, the difference between the resonance frequency point of the main antenna and the resonance frequency point of the parasitic antenna may be an absolute value of a relative difference, and is specifically a percentage of an absolute value of the difference between the resonance frequency point of the main antenna and the resonance frequency point of the parasitic antenna to an intermediate value of the two resonance frequency points. For example, if the resonance frequency point of the main antenna is f1, and the resonance frequency point of the parasitic antenna is f2, the difference between the resonance frequency point of the main antenna and the resonance frequency point of the parasitic antenna is |f1-f2|/½(f1+f2).

In this case, if a difference between a resonance frequency point of a main antenna 1 and a resonance frequency point of a parasitic antenna 2 is an absolute value of an absolute difference, a target threshold is a frequency value. However, if the difference between the resonance frequency point of the main antenna 1 and the resonance frequency point of the parasitic antenna 2 is an absolute value of a relative difference, the target threshold is a percentage.

In the solution shown in this disclosure, the antenna includes a main antenna and a parasitic antenna. The main antenna and the parasitic antenna are disposed at opposite positions. An excitation signal of the main antenna is introduced through a feeder, and an excitation signal of the parasitic antenna is introduced through an electromagnetic field coupled to the main antenna. The main antenna and the parasitic antenna are coupled to each other, so that a bandwidth of the antenna can be expanded. In this case, the antenna is used in a vehicle as a communication antenna of the vehicle, for example, a 4G communication antenna or a 5G communication antenna, to implement 4G or 5G wide bandwidth coverage, or even full bandwidth coverage.

In addition, the antenna can further improve an out-of-band suppression degree and improve an anti-inter-frequency interference feature. For example, the antenna can improve an out-of-band suppression degree of a GNSS antenna, so that even if the GNSS antenna and the antenna in this embodiment are disposed together, for example, both are disposed on a shark fin or both are disposed in a luggage rack, interference of the GNSS antenna to the antenna in this embodiment can be reduced.

In a possible implementation, the feeding point of the main antenna is connected to an inner conductor of a feeding transmission line of the mainboard, an outer conductor of the feeding transmission line is connected to a first ground end of the mainboard, and the first ground end and the second ground end are co-grounded.

In the solution shown in this disclosure, co-grounding can eliminate an invalid resonance mode that is excited after the main antenna and the parasitic antenna are coupled, thereby slowing down a rate of efficiency decrease of an effective resonance mode. For example, after the main antenna and the parasitic antenna are coupled, an effective resonance mode 2 and an invalid resonance mode 3 can be excited. Resonance points corresponding to the two resonance modes are close. If the invalid resonance mode 3 is eliminated through co-grounding, because a resonance point 3 is not a corresponding minimum value point in a radiation efficiency feature diagram, a radiation loss from a resonance point 2 to the resonance point 3 does not decrease rapidly. Therefore, the invalid resonance mode 3 is eliminated, so that a decrease rate of the radiation loss of the resonance mode 2 can be reduced, that is, a decrease rate of efficiency of the resonance mode 2 is slowed down.

In a possible implementation, the main antenna is a monopole antenna, and the parasitic antenna is a ring antenna.

In the solution shown in this disclosure, the monopole antenna is an antenna that can excite a specific wavelength line mode after an excitation signal is input to the monopole antenna. For example, after an excitation signal is input to the monopole antenna, a resonance mode of a ¼ wavelength line mode can be excited.

The ring antenna may also be referred to as a ring-shaped antenna, and is a structure in which a metal conductor is wound into a specific shape, such as a circle, a square, or a triangle, and two ends of the conductor are used as output ends. After an excitation signal is input into the ring antenna, a resonance mode of a specific wavelength ring mode can be excited, for example, a resonance mode of a ½ wavelength ring mode can be excited.

In a possible implementation, a start end of the main antenna is the feeding point, and both ends of the parasitic antenna are connected to a second ground end of the mainboard; and
a distance between the start end of the main antenna and an end part of the parasitic antenna is less than a first value, and a distance between a tail end of the main antenna and a middle position of the parasitic antenna is less than a second value.

In the solution shown in this disclosure, the main antenna is the monopole antenna, and the start end is a current strong point position, and corresponds to a magnetic field strong point. The tail end is a current weak point position, and corresponds to an electric field strong point. The parasitic antenna is the ring antenna, and the two ends are current strong point positions, and correspond to magnetic field strong points. The middle position is a current weak point position, and corresponds to an electric field strong point.

In this case, when a coupling degree between the main antenna and the parasitic antenna is adjusted, the start end of the main antenna may be adjusted to be close to the end part of the parasitic antenna, and the tail end of the main antenna may be adjusted to be close to the middle position of the parasitic antenna.

In the solution shown in this disclosure, the coupling degree between the main antenna and the parasitic antenna is adjusted, so that a resonance frequency and a bandwidth after mutual coupling can be adjusted, to implement wide bandwidth coverage of the antenna.

In the solution shown in this disclosure, a location of an out-of-band radiation zero point can be further adjusted by adjusting the coupling degree between the main antenna and the parasitic antenna.

In a possible implementation, the main antenna is a monopole antenna, and the parasitic antenna is a monopole antenna.

In a possible implementation, a start end of the main antenna is a feeding point, and a start end of the parasitic antenna is connected to the second ground end of the mainboard; and
a distance between the start end of the main antenna and the start end of the parasitic antenna is less than a third value, and a distance between a tail end of the main antenna and a tail end of the parasitic antenna is less than a fourth value.

In the solution shown in this disclosure, the main antenna is the monopole antenna, and the start end is a current strong point position, and corresponds to a magnetic field strong point. The tail end is a current weak point position, and corresponds to an electric field strong point. The parasitic antenna is the monopole antenna, and the start end connected to the mainboard is a current strong point position, and corresponds to a magnetic field strong point. The tail end is a current weak point position, and corresponds to an electric field strong point.

In this case, when the coupling degree between the main antenna and the parasitic antenna is adjusted, the start end of the main antenna may be adjusted to be close to the start end of the parasitic antenna, and the tail end of the main antenna may be adjusted to be close to the tail end of the parasitic antenna.

In the solution shown in this disclosure, the coupling degree between the main antenna and the parasitic antenna is adjusted, so that a resonance frequency and a bandwidth after mutual coupling can be adjusted, to implement wide bandwidth coverage of the antenna.

In the solution shown in this disclosure, a location of an out-of-band radiation zero point can be further adjusted by adjusting the coupling degree between the main antenna and the parasitic antenna.

In a possible implementation, the main antenna is a ring antenna, and the parasitic antenna is a ring antenna or a monopole antenna.

In a possible implementation, the main antenna includes a first stub and a second stub; and
one end of the first stub is vertically located on the surface of the mainboard, the other end is connected to the second stub, and a width of the second stub is greater than a width of the first stub.

In the solution shown in this disclosure, the second stub is wide, and there are a plurality of current paths distributed on the second stub. Although electrical lengths corresponding to these current paths are similar, the electrical lengths are slightly different. Different electrical lengths excite different resonance frequencies. Therefore, a plurality of different electrical lengths excite a plurality of resonance frequencies that are close but different, thereby helping expand a bandwidth of an antenna.

In a possible implementation, the main antenna further includes a first matching stub;
there is a spacing between the second stub and the mainboard, and the first matching stub is fastened to the mainboard, is located on one side of the first stub, and is located between the second stub and the mainboard; and
edges that are of the first matching stub and the first stub and that are close to each other, and/or edges that are of the first matching stub and the second stub and that are close to each other are all configured to form a capacitor.

In the solution shown in this disclosure, a capacitor can be formed between the edges that are of the first matching stub and the first stub and that are close to each other, and/or between the edges that are of the first matching stub and the second stub and that are close to each other. The formed capacitor can be used to adjust impedance matching between the antenna and the feeder, to reduce a return loss and improve radiation efficiency of the antenna.

In a possible implementation, the second stub includes a first branch and a second branch, and the first branch and the second branch are disposed side by side in a width direction of the second stub; and
one end of the first branch is connected to one end of the second branch, and the other end of the first branch and the other end of the second branch are both connected to the first stub.

In the solution shown in this disclosure, because the second stub is wide, the second stub may be hollowed out, so that the second stub includes a hollow area, and a first branch and a second branch that are located on left and right sides of the hollow area.

The second stub includes the first branch and the second branch that are separated. In this case, a current distributed on the first branch can excite an electromagnetic wave of a resonance frequency, and a current distributed on the second branch can excite an electromagnetic wave of another resonance frequency, so that a quantity of resonance frequencies of the antenna can be increased, and a bandwidth of the antenna can be expanded by increasing the quantity of resonance frequencies.

In a possible implementation, the main antenna includes a first radiation arm, a second radiation arm, and a third radiation arm; and
one end of the first radiation arm is vertically located on the surface of the mainboard, the other end is vertically connected to one end of the second radiation arm, and the other end of the second radiation arm is vertically connected to one end of the third radiation arm.

In the solution shown in this disclosure, the first radiation arm is vertically disposed relative to the mainboard, the second radiation arm is horizontally disposed relative to the mainboard, and the third radiation arm is vertically disposed relative to the mainboard. A manner of disposing the three radiation arms of the main antenna helps reduce a height and a width, so that a structure of the main antenna is more compact.

In a possible implementation, a total height of the main antenna is equal to a total height of the parasitic antenna, and a total width of the main antenna is equal to a total width of the parasitic antenna.

In the solution shown in this disclosure, the total height of the main antenna is equal to or close to the total height of the parasitic antenna, and the total width of the main antenna is equal to or close to the total width of the parasitic antenna. This helps the main antenna and the parasitic antenna fully use a space size.

In a possible implementation, the antenna further includes a dielectric plate, the dielectric plate is vertically located on the surface of the mainboard, the main antenna is located on a first surface of the dielectric plate, the parasitic antenna is located on a second surface of the dielectric plate, and the first surface and the second surface of the dielectric plate are opposite to each other.

In the solution shown in this disclosure, the dielectric plate is vertically located on the surface of the mainboard, and the main antenna and the parasitic antenna may be printed on two surfaces that are opposite to each other and that are of the dielectric plate. For example, the main antenna is located on the first surface of the dielectric plate, and the parasitic antenna is located on the second surface of the dielectric plate.

In the solution shown in this disclosure, the main antenna and the parasitic antenna are disposed on the two opposite surfaces of the dielectric plate, so that shockproof performance of the antenna can be improved. In this case, when the antenna is used in the vehicle, a degree of shaking of the antenna with the vehicle can be reduced.

According to a second aspect, an antenna system is provided, where the antenna system includes a radio frequency circuit and the antenna according to the first aspect, and the radio frequency circuit is configured to receive and send a radio signal through the antenna.

According to a third aspect, a vehicle is provided, where the vehicle includes the antenna system according to the second aspect.

In a possible implementation, the antenna is located in a luggage rack of the vehicle.

In the solution shown in this disclosure, the antenna may be located in a luggage rack on the left side of the vehicle body, or may be disposed in a luggage rack on the right side of the vehicle body, or may be disposed in both a luggage rack on the left side of the vehicle body and a luggage rack on the right side of the vehicle body.

In a possible implementation, the radio frequency circuit is disposed in a telematics box T-BOX of the vehicle, the T-BOX is located on a rear seat, and is close to a tail that is of the vehicle and that is close to a tire, and the luggage rack in which the antenna is located and the T-BOX are located on a same side of a vehicle body of the vehicle.

In the solution shown in this disclosure, the T-BOX is located on a rear seat, and is close to a tail that is of the vehicle and that is close to a tire. In addition, the luggage rack in which the antenna is located and the T-BOX are located on a same side of the vehicle body, so that a space distance between the antenna and the T-BOX is short. In this case, a harness of a signal cable is short. This can effectively reduce a link loss caused by a cable, thereby improving system efficiency of an entire vehicle antenna.

In a possible implementation, the antenna is located in a shark fin of the vehicle.

### BRIEF DESCRIPTION OF DRAWINGS

FIG. 1 is a diagram of a structure of an antenna according to this disclosure;

FIG. 2 is a diagram of current distribution in an excited ¼ wavelength line mode according to this disclosure;

FIG. 3 is a diagram of current distribution in an excited ½ wavelength ring mode according to this disclosure;

FIG. 4 is a diagram of a structure of a main antenna that is a monopole antenna according to this disclosure;

FIG. 5 is a diagram of a structure of a parasitic antenna that is a ring antenna according to this disclosure;

FIG. 6 is a diagram of a structure of an antenna according to this disclosure;

FIG. 7 is a diagram of distribution of a plurality of current paths on a main antenna according to this disclosure;

FIG. 8 is a diagram of a structure of a main antenna having a hollow area according to this disclosure;

FIG. 9 is a diagram of a structure of a main antenna having a matching stub according to this disclosure;

FIG. 10 is a diagram of a structure of a main antenna according to this disclosure;

FIG. 11 is a diagram of a structure of a parasitic antenna according to this disclosure;

FIG. 12 is a diagram of a structure of an antenna according to this disclosure;

FIG. 13 is a diagram of a return loss feature of an antenna shown in FIG. 12 according to this disclosure;

FIG. 14 is a diagram of a radiation efficiency feature of an antenna shown in FIG. 12 according to this disclosure;

FIG. 15 is a diagram of a system efficiency feature of an antenna shown in FIG. 12 according to this disclosure;

FIG. 16 is a diagram of current distribution in an excited ¼ wavelength line mode according to this disclosure;

FIG. 17 is a diagram of current distribution in an excited ¼ wavelength line mode according to this disclosure;

FIG. 18 is a diagram of a structure of an antenna according to this disclosure;

FIG. 19 is a diagram of current distribution on a main antenna and a parasitic antenna according to this disclosure, where (a) is a main view, and (b) is a top view;

FIG. 20 is a diagram of current distribution on a main antenna and a parasitic antenna according to this disclosure, where (a) is a main view, and (b) is a top view;

FIG. 21 is a diagram of current distribution on a main antenna and a parasitic antenna according to this disclosure, where (a) is a main view, and (b) is a top view;

FIG. 22 is a diagram of a return loss feature of an antenna according to this disclosure;

FIG. 23 is a diagram of a radiation efficiency feature of an antenna and a diagram of a system efficiency feature of the antenna according to this disclosure;

FIG. 24 is a diagram of a structure of an antenna mounted in a luggage rack according to this disclosure; and

FIG. 25 is a diagram of a structure in which a mainboard of an antenna is located in a metal base of a luggage rack according to this disclosure.

### REFERENCE NUMERALS

1: main antenna; 11: first radiation arm; 12: second radiation arm; 13: third radiation arm; 14: first matching stub; 15: second matching stub; 111: first stub; 112: second stub; 121: first inclined stub; 122: horizontal stub; 123: second inclined stub; 1120: hollow area; 1121: first branch; 1122: second branch;
2: parasitic antenna;
3: mainboard; 31: first ground plane; and 32: second ground plane.

### DESCRIPTION OF EMBODIMENTS

Although this disclosure is described with reference to some embodiments, this does not mean that features of this application are limited only to the implementations. On the contrary, an objective of describing this application with reference to implementations is to cover another option or modification that may be derived based on claims of this disclosure. To provide an in-depth understanding of this disclosure, the following descriptions include a plurality of specific details. This disclosure may alternatively be implemented without using these details. In addition, to avoid confusing or blurring a focus of this disclosure, some specific details are omitted from the descriptions. It should be noted that embodiments in this disclosure and the features in embodiments may be mutually combined in the case of no conflict.

In embodiments of this disclosure, the terms “first”, “second”, “third”, and “fourth” are merely intended for a purpose of description, and shall not be understood as an indication or implication of relative importance or an implicit indication of a quantity of indicated technical features. Therefore, a feature defined by “first”, “second”, “third”, or “fourth” may explicitly or implicitly include one or more features.

“And/Or” in embodiments of this disclosure describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

In the descriptions of embodiments of this disclosure, it should be noted that terms “mounting” and “connection” should be understood in a broad sense unless there is a clear stipulation and limitation. For example, “connection” may be a detachable connection, a nondetachable connection, a direct connection, or an indirect connection through an intermediate medium. The orientation terms mentioned in embodiments of this disclosure, such as “up”, “down”, “left”, and “right”, are merely directions for reference in the accompanying drawings. Therefore, the orientation terms are used to better and more clearly describe and understand embodiments of this disclosure, instead of indicating or implying that the apparatus or element to which the orientation terms should have a specific orientation, and be constructed and operated in a specific orientation. Therefore, the orientation terms cannot be understood as a limitation on embodiments of this disclosure.

This embodiment relates to an antenna of a vehicle. The antenna is configured to implement communication between the vehicle and a base station, and is usually disposed in a shark fin on a roof of the vehicle or a luggage rack on the roof of the vehicle. However, because heights of the shark fin and the luggage rack are limited, a size of the antenna is limited. A radiation frequency of the antenna is related to the size of the antenna. For example, the radiation frequency is negatively correlated with the size of the antenna. Consequently, it is difficult for the antenna to implement wideband coverage.

However, the antenna provided in this embodiment is used in the vehicle, so that an operating bandwidth of the antenna can be expanded, to implement wideband coverage. In addition, the antenna can further improve an out-of-band interference suppression degree, to resist out-of-band adjacent-channel interference.

The antenna may be a transmit antenna, a receive antenna, or a transceiver antenna. This is not specifically limited in this embodiment.

The antenna may be specifically an antenna of a cellular mobile communication system, for example, a 4th generation mobile communication technology (4th generation mobile networks, 4G) antenna, or a 5th generation mobile communication technology (5th generation mobile networks, 5G) antenna. The antenna may alternatively be a communication antenna of a wireless local area network (WLAN), a vehicle to X (V2X) technology, Bluetooth low energy (BLE), or the like.

For example, the antenna may be a 4G full frequency antenna, or may be a 5G full frequency antenna. A type of the antenna is not limited in this embodiment.

Before the solution is described, terms involved in the solution are first described.

A resonance frequency, also referred to as a resonance frequency point or a resonance point, is generally a center frequency of an expected operating frequency band, and is a frequency point at which a current and a voltage of the antenna reach maximum values. At this frequency point, radiation efficiency of the antenna is the highest, and the antenna can convert electric energy into an electromagnetic wave and transmit the electromagnetic wave.

A bandwidth is also an operating frequency band of the antenna, and generally covers the resonance frequency. The bandwidth usually refers to a frequency range in which a return loss is less than a value of a specific dB value. For example, a frequency range in which a return loss is less than −5 dB may be defined as the bandwidth of the antenna.

A return loss is a ratio of reflected power to incident power at a connector of the antenna, and reflects an impedance matching feature between the antenna and a feeding transmission line. For example, better impedance matching between the antenna and the feeding transmission line indicates a smaller return loss.

In a diagram of a return loss feature in this embodiment, the return loss is represented by a negative value. Therefore, a smaller return loss indicates a better impedance matching feature of the antenna, and a return loss of 0 dB corresponds to worst impedance matching.

Radiation efficiency is a ratio of energy radiated by the antenna to energy transmitted to the antenna, where energy that is not radiated is mainly consumed by the antenna.

System efficiency, also referred to as antenna efficiency, is a ratio of radiation power of the antenna to input power provided by a feeder. Energy that is not radiated by the antenna is partially reflected back and partially consumed by the antenna.

A radiation zero point is a frequency point at which neither an electromagnetic wave is radiated nor an electromagnetic wave is received in theory. In practice, a loss at the radiation zero point is large, and efficiency is low. In a diagram of an efficiency feature, the radiation zero point corresponds to a minimum value point.

The following describes a structure of the antenna provided in this embodiment.

The antenna provided in this embodiment mainly increases a quantity of resonance modes of the antenna by using electromagnetic field coupling between a main antenna and a parasitic antenna, to expand an antenna bandwidth.

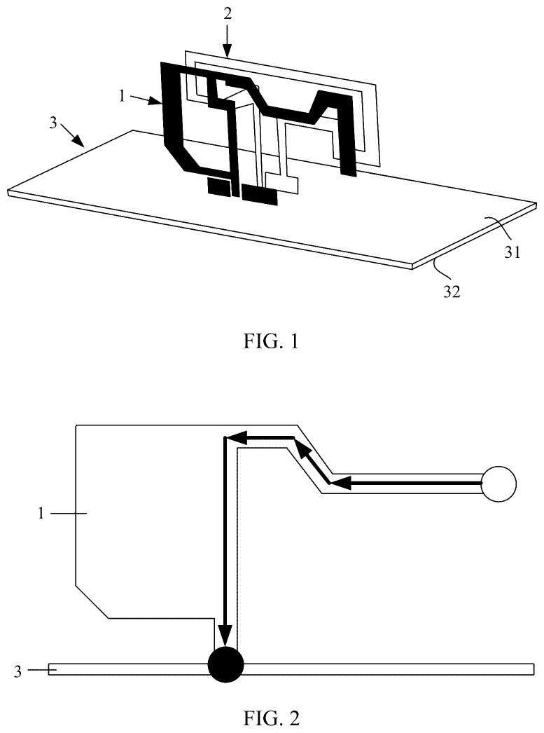

As shown in FIG. 1, the antenna includes a main antenna 1, a parasitic antenna 2, and a mainboard 3. The main antenna 1 and the parasitic antenna 2 are both located on a surface of the mainboard 3. For example, the main antenna 1 and the parasitic antenna 2 are both vertically welded on the surface of the mainboard 3. Still refer to FIG. 1. A plane on which the main antenna 1 is located and a plane on which the parasitic antenna 2 is located are parallel, and are opposite to each other.

In an example, the antenna may further include a dielectric plate. The dielectric plate is vertically located on the surface of the mainboard 3. The main antenna 1 and the parasitic antenna 2 may be printed on two opposite surfaces of the dielectric plate. For example, the main antenna 1 is located on a first surface of the dielectric plate, and the parasitic antenna 2 is located on a second surface of the dielectric plate.

In another example, the antenna may not include a dielectric plate, and both the main antenna 1 and the parasitic antenna 2 are metal sheets.

It should be noted that the main antenna 1 and the parasitic antenna 2 are disposed on the two opposite surfaces of the dielectric plate, so that shockproof performance of the antenna can be improved. In this case, when the antenna is used in a vehicle, a degree of shaking of the antenna with the vehicle can be reduced.

In an example, the main antenna 1 is an active conductive element in the radio antenna, and is connected to a radio frequency circuit through a feeding transmission line (which is referred to as a feeder for short). For example, a feeding point of the main antenna 1 is connected to a feeder on the mainboard 3. The feeder is usually a coaxial line, and includes an inner conductor and an outer conductor. In this case, the feeding point of the main antenna 1 is connected to the inner conductor of the feeder, and the outer conductor of the feeder is connected to a first ground end of the mainboard 3, to implement grounding.

In an example, the parasitic antenna 2 is a passive conductive element in the radio antenna, and is not connected to a feeder. An excitation signal of the parasitic antenna 2 is introduced by using electric field coupling and magnetic field coupling between the parasitic antenna 2 and the main antenna 1.

In an example, the parasitic antenna 2 is connected to a second ground end of the mainboard 3, so that the parasitic antenna 2 is grounded. The parasitic antenna 2 is grounded, so that the mainboard 3 may serve as a radiation element of the parasitic antenna 2, to radiate an electromagnetic wave outward, thereby effectively shortening a size of the parasitic antenna 2.

As described above, the outer conductor of the feeder connected to the main antenna 1 is connected to the first ground end of the mainboard 3, to implement grounding; and the parasitic antenna 2 is connected to the second ground end of the mainboard 3, to implement grounding. The main antenna 1 and the parasitic antenna 2 may be co-grounded, and co-grounding means that ground planes referenced by the main antenna 1 and the parasitic antenna 2 are consistent.

The main antenna 1 and the parasitic antenna 2 are co-grounded, that is, the first ground end connected to the outer conductor of the feeder and the second ground end connected to the parasitic antenna 2 are co-grounded.

For example, as shown in FIG. 1, an upper surface of the mainboard 3 represents a first ground plane 31, and a lower surface represents a second ground plane 32. If the first ground end and the second ground end are both located on the upper surface of the mainboard 3, that is, the outer conductor of the feeder and the parasitic antenna 2 are both connected to the upper surface of the mainboard 3. In this case, the ground planes referenced by the main antenna 1 and the parasitic antenna 2 are consistent, and both are the first ground plane 31.

If the first ground end and the second ground end are both located on the lower surface of the mainboard 3, that is, the outer conductor of the feeder and the parasitic antenna 2 are both connected to the lower surface of the mainboard 3. In this case, the ground planes referenced by the main antenna 1 and the parasitic antenna 2 are also consistent, and both are the second ground plane 32.

However, if one of the first ground end and the second ground end is located on the upper surface of the mainboard 3, the other is located on the lower surface of the mainboard 3, and the upper surface and the lower surface are connected through a metal through hole of the mainboard 3, the first ground plane 31 and the second ground plane 32 represent a same ground plane, and the ground planes referenced by the main antenna 1 and the parasitic antenna 2 are also consistent.

The foregoing describes a case in which the main antenna 1 and the parasitic antenna 2 are co-grounded and an implementation of co-grounding.

In another example, the main antenna 1 and the parasitic antenna 2 may not be co-grounded, that is, the ground planes referenced by the main antenna 1 and the parasitic antenna 2 are inconsistent.

For example, the upper surface of the mainboard 3 still represents the first ground plane 31, and the lower surface represents the second ground plane 32. In an example, the outer conductor of the feeder connected to the main antenna 1 may be connected to the upper surface of the mainboard 3, and a referenced ground plane is the first ground plane 31. The parasitic antenna 2 may be connected to the lower surface of the mainboard 3, and a referenced ground plane is the second ground plane 32. There is no electrical connection relationship between the first ground plane 31 and the second ground plane 32, so that the main antenna 1 and the parasitic antenna 2 are not co-grounded. To ensure that the parasitic antenna 2 is not connected to the upper surface of the mainboard 3 when the parasitic antenna 2 is connected to the lower surface of the mainboard 3, a groove may be provided in the mainboard 3, and the parasitic antenna 3 passes through the groove to be connected to the lower surface of the mainboard 3.

Whether the main antenna 1 and the parasitic antenna 2 are co-grounded is not specifically limited in this embodiment, and may be flexibly selected based on an antenna design requirement and expected effect achieved. The following describes effect generated when the main antenna 1 and the parasitic antenna 2 are co-grounded in the following description of a resonance mode of the antenna.

As described above, the antenna increases the quantity of resonance modes of the antenna by using coupling between the main antenna 1 and the parasitic antenna 2, to expand a resonance frequency band of the antenna. In this case, a resonance frequency point of the main antenna 1 is close to a resonance frequency point of the parasitic antenna 2. For example, a difference between the resonance frequency point of the main antenna 1 and the resonance frequency point of the parasitic antenna 2 is less than a target threshold.

In an example, the difference between the resonance frequency point of the main antenna 1 and the resonance frequency point of the parasitic antenna 2 may be an absolute value of an absolute difference, and is specifically an absolute value of the difference between the resonance frequency point of the main antenna 1 and the resonance frequency point of the parasitic antenna 2. For example, if the resonance frequency point of the main antenna is f1, and the resonance frequency point of the parasitic antenna is f2, the difference between the resonance frequency point of the main antenna and the resonance frequency point of the parasitic antenna is |f1−f2|.

Alternatively, the difference between the resonance frequency point of the main antenna 1 and the resonance frequency point of the parasitic antenna 2 may be an absolute value of a relative difference, and is specifically a percentage of an absolute value of the difference between the resonance frequency point of the main antenna 1 and the resonance frequency point of the parasitic antenna 2 to an intermediate value of the two resonance frequency points. For example, if the resonance frequency point of the main antenna is f1, and the resonance frequency point of the parasitic antenna is f2, the difference between the resonance frequency point of the main antenna and the resonance frequency point of the parasitic antenna is

$$\vert f 1 - f 2 \vert / \frac{1}{2} ( f 1 + f 2 ) .$$

In this case, if the difference between the resonance frequency point of the main antenna 1 and the resonance frequency point of the parasitic antenna 2 is an absolute value of an absolute difference, the target threshold is a frequency value. However, if the difference between the resonance frequency point of the main antenna 1 and the resonance frequency point of the parasitic antenna 2 is an absolute value of a relative difference, the target threshold is a percentage.

Regardless of whether the target threshold is a frequency value or a percentage, the target threshold is related to a frequency band in which the main antenna 1 is located and a frequency band in which the parasitic antenna 2 is located. In other words, if the main antenna 1 and the parasitic antenna 2 are located in different frequency bands, the target threshold varies. The frequency bands in which the main antenna 1 and the parasitic antenna 2 are located are related to a frequency band to be expanded by the antenna.

For example, in cellular communication, operating frequency bands of a 4G antenna and a 5G antenna are usually divided into a low frequency band (700 MHz to 960 MHz), a medium-high frequency band (1710 MHz to 2690 MHz), and a high frequency band (3300 MHz to 5000 MHz).

If the antenna expands a coverage bandwidth of the low frequency band through the parasitic antenna 2, both the resonance frequency point of the main antenna 1 and the resonance frequency point of the parasitic antenna 2 are located in the low frequency band, an absolute value of an absolute difference between the resonance frequency point of the main antenna 1 and the resonance frequency point of the parasitic antenna 2 is less than 350 M, and an absolute value of a relative difference between the resonance frequency point of the main antenna 1 and the resonance frequency point of the parasitic antenna 2 is less than 42%.

If the antenna expands the coverage bandwidth of the medium-high frequency band through the parasitic antenna 2, both the resonance frequency point of the main antenna 1 and the resonance frequency point the parasitic antenna 2 are located in the medium-high frequency band, an absolute value of an absolute difference between the resonance frequency point of the main antenna 1 and the resonance frequency point of the parasitic antenna 2 is less than 600 M, and an absolute value of a relative difference between the resonance frequency point of the main antenna 1 and the resonance frequency point of the parasitic antenna 2 is less than 40%.

If the antenna expands the coverage bandwidth of the high frequency band through the parasitic antenna 2, both the resonance frequency point of the main antenna 1 and the resonance frequency point of the parasitic antenna 2 are located in the high frequency band, an absolute value of an absolute difference between the resonance frequency point of the main antenna 1 and the resonance frequency point of the parasitic antenna 2 is less than 800M, and an absolute value of a relative difference between the resonance frequency point of the main antenna 1 and the resonance frequency point of the parasitic antenna 2 is less than 25%.

It can be learned from the foregoing that the antenna increases the quantity of resonance modes of the antenna by using electromagnetic field coupling between the main antenna 1 and the parasitic antenna 2, to expand an antenna frequency band. A coupling degree between the main antenna 1 and the parasitic antenna 2 affects a resonance frequency of the antenna. Therefore, the resonance frequency of the antenna can be adjusted by adjusting the coupling degree between the main antenna 1 and the parasitic antenna 2.

In an example, the coupling degree between the main antenna 1 and the parasitic antenna 2 may be adjusted by adjusting a position relationship between an electric field strong point position of the main antenna 1 and an electric field strong point position of the parasitic antenna 2, and a position relationship between a magnetic field strong point position of the main antenna 1 and a magnetic field strong point position of the parasitic antenna 2.

Generally, a current strong point corresponds to the magnetic field strong point, and a current weak point corresponds to the electric field strong point.

Therefore, the key to adjusting the coupling degree between the main antenna 1 and the parasitic antenna 2 is to adjust a position relationship between a current strong point position of the main antenna 1 and a current strong point position of the parasitic antenna 2, and adjust a position relationship between a current weak point position of the main antenna 1 and a current weak point position of the parasitic antenna 2.

The current strong point position and the current weak point position are related to a type of the antenna.

For example, for a monopole antenna, as shown in FIG. 2, in current distribution of an excited ¼ wavelength line mode, a current at a feeding point is the strongest, and a current at an open end is the weakest. Generally, one end of the monopole antenna connected to the mainboard 3 is denoted as a start end, and is used as a feeding point. The other end is an open end, and is denoted as a tail end. Therefore, for the monopole antenna, the start end is a current strong point position, and the tail end is a current weak point position.

It should be noted that, in FIG. 2, a solid dot filled with black represents a current strong point position, and a dot without filling represents a current weak point position. This representation manner is also applicable to other accompanying drawings. An arrow in FIG. 2 represents a current at a moment, and an arrow in another accompanying drawing also represents a current at a moment.

FIG. 2 is a diagram of current distribution at a moment when a current is loaded on a monopole antenna shown in FIG. 4.

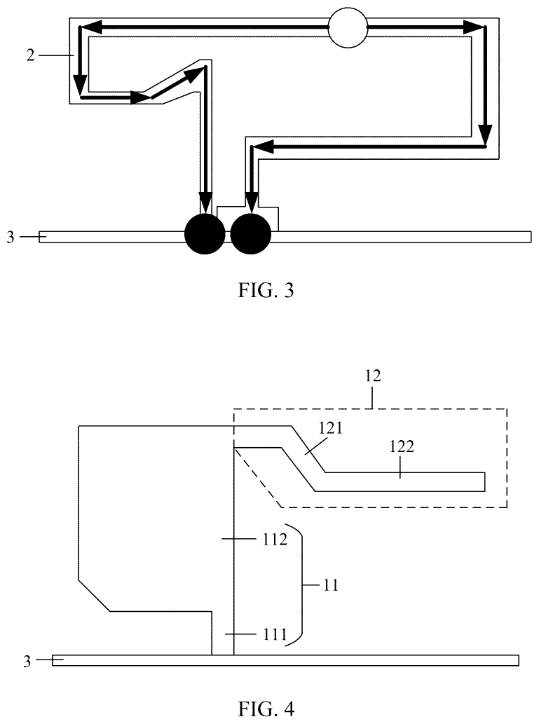

For another example, for a ring antenna, as shown in FIG. 3, in current distribution of an excited ½ wavelength ring mode, a current at a middle position (that is, a ¼ wavelength position) is the weakest, and currents at positions of two ends are the strongest. Therefore, for the ring antenna, the middle position is a current weak point position, and the two ends are current strong point positions.

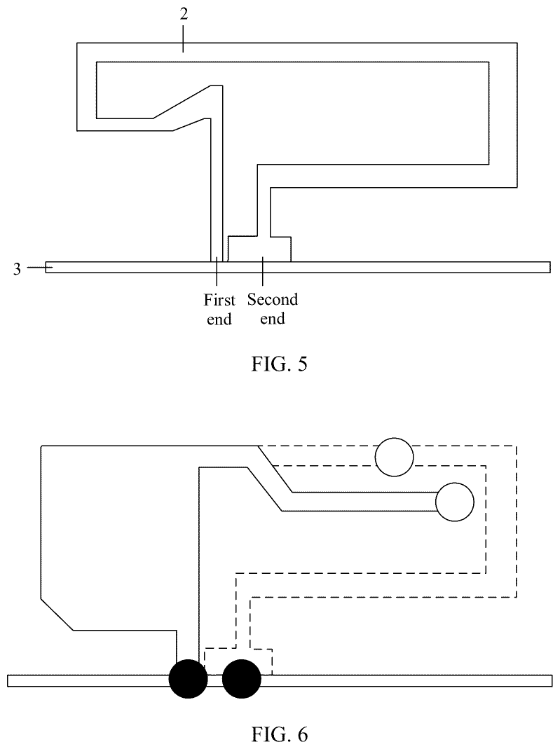

FIG. 3 is a diagram of current distribution at a moment when a current is loaded on a monopole antenna shown in FIG. 5.

Based on the foregoing description, in an example, a space distance between a current strong point position of the main antenna 1 and a current strong point position of the parasitic antenna 2, and a space distance between a current weak point position of the main antenna 1 and a current weak point position of the parasitic antenna 2 may be adjusted by using simulation software, to optimize electromagnetic field coupling effect between the main antenna 1 and the parasitic antenna 2, so that an operating frequency band of the antenna is wide, and an expected bandwidth is met, thereby implementing wide bandwidth coverage of the antenna.

For example, for antenna types of the main antenna 1 and the parasitic antenna 2, the main antenna 1 may be a monopole antenna or a ring antenna, and the parasitic antenna 2 may also be a monopole antenna or a ring antenna. In this case, there are the following four solutions.

In one solution, the main antenna 1 is a monopole antenna, and the parasitic antenna 2 is a ring antenna. In another solution, both the main antenna 1 and the parasitic antenna 2 are ring antennas. In another solution, both the main antenna 1 and the parasitic antenna 2 are monopole antennas. In another solution, the main antenna 1 is a ring antenna, and the parasitic antenna 2 is a monopole antenna.

The following separately describes features of the antenna when the main antenna 1 is the monopole antenna, the parasitic antenna 2 is the ring antenna, or the main antenna 1 and the parasitic antenna 2 are both monopole antennas.

The monopole antenna is an antenna that can excite a specific wavelength line mode after an excitation signal is input to the monopole antenna. For example, when the excitation signal is input to the monopole antenna, a resonance mode of a ¼ wavelength line mode can be excited.

The ring antenna may also be referred to as a ring-shaped antenna, and is a structure in which a metal conductor is wound into a specific shape, such as a circle, a square, or a triangle, and two ends of the conductor are used as output ends. After an excitation signal is input to the ring antenna, a resonance mode of a specific wavelength ring mode can be excited, for example, a resonance mode of a ½ wavelength ring mode can be excited.

(1) The main antenna 1 is the monopole antenna, and the parasitic antenna 2 is the ring antenna.

FIG. 4 is a diagram of a structure of a main antenna 1. One end of the main antenna 1 is fastened to the surface of the mainboard 3, and the other end is open. The main antenna 1 is the monopole antenna. In this case, as described above, the end fastened to the mainboard 3 is denoted as a start end, the open end is denoted as a tail end, the start end is a feeding point, a current strong point position of the main antenna 1 is the start end, and a current weak point position is the tail end.

FIG. 5 is a diagram of a structure of a parasitic antenna 2. Both ends (that is, a first end and a second end) of the parasitic antenna 2 are fastened to the surface of the mainboard 3, and both ends are electrically connected to the mainboard 3, to implement grounding at both ends. The parasitic antenna 2 is the ring antenna. As described above, a middle position of the parasitic antenna 2 is a current weak point position, and the two ends are current strong point positions.

Therefore, when the coupling degree between the main antenna 1 and the parasitic antenna 2 is adjusted, a position relationship between the start end of the main antenna 1 and the end part of the parasitic antenna 2 may be adjusted, and a position relationship between the tail end of the main antenna 1 and the middle position of the parasitic antenna 2 may be adjusted, so that the antenna obtained by coupling between the main antenna 1 and the parasitic antenna 2 includes a plurality of resonance modes, to expand a coverage bandwidth of the antenna.

In an example, the position relationship between the start end of the main antenna 1 and the end part of the parasitic antenna 2 is adjusted. For example, a distance between the start end of the main antenna 1 and the end part of the parasitic antenna 2 is less than a first value, so that the start end of the main antenna 1 and the two ends of the parasitic antenna 2 are close. Refer to FIG. 6 (for ease of distinguishing between the main antenna 1 and the parasitic antenna 2, in FIG. 6, a solid line represents the main antenna 1, and a dashed line represents the parasitic antenna 2).

Similarly, a position relationship between the tail end of the main antenna 1 and the middle position of the parasitic antenna 2 is adjusted. For example, a distance between the tail end of the main antenna 1 and the middle position of the parasitic antenna 2 is less than a second value, so that the tail end of the main antenna 1 and the middle position of the parasitic antenna 2 are close. Refer to FIG. 6.

Because both the first end and the second end of the parasitic antenna 2 are current strong point positions, as shown in FIG. 6, a distance between the start end of the main antenna 1 and the end part of the parasitic antenna 2 may be a distance between the start end of the main antenna 1 and the first end of the parasitic antenna 2. Certainly, the distance may alternatively be a distance between the start end of the main antenna 1 and the second end of the parasitic antenna 2, and may further include a distance between the start end of the main antenna 1 and the first end of the parasitic antenna 2, and the distance between the start end of the main antenna 1 and the second end of the parasitic antenna 2.

The first value and the second value may be determined by using a simulation result. In addition, because the main antenna 1 and the parasitic antenna 2 are located in different resonance frequency bands, values of the first value and the second value are also different. For example, if frequency bands in which resonance frequency points of the main antenna 1 and the parasitic antenna 2 are located are both low frequency bands (700 MHz to 960 MHZ), the first value may be 8 mm, and the second value may be 35 mm.

The foregoing distances are all space distances in three-dimensional space.

It should be noted that, to enable the parasitic antenna 2 to be the ring antenna, a distance between the two ends of the parasitic antenna 2 cannot be too large, and is usually less than a value, for example, less than 25 mm.

For the antenna shown in FIG. 6, a position relationship between the start end of the main antenna 1 and the first end of the parasitic antenna 2 is adjusted, and a position relationship between the tail end of the main antenna 1 and the middle position of the parasitic antenna 2 is adjusted, so that the antenna can have at least current distribution shown in FIG. 2 and current distribution shown in FIG. 3, to excite at least a resonance mode of ¼ wavelength line mode and a resonance mode of a ½ wavelength ring mode.

The foregoing is about a position relationship disposing between the main antenna 1 and the parasitic antenna 2. The following describes a structural feature of the main antenna 1, a structural feature of the parasitic antenna 2, and a simulation result.

(1) Structural feature of the main antenna 1.

As shown in FIG. 4, the main antenna 1 includes a first radiation arm 11 and a second radiation arm 12. One end of the first radiation arm 11 is vertically fastened to the surface of the mainboard 3, and the other end is vertically connected to the second radiation arm 12. In other words, the first radiation arm 11 is vertically disposed relative to the mainboard 3, and the second radiation arm 12 is horizontally disposed relative to the mainboard 3. The main antenna 1 includes the vertical first radiation arm 11 and the horizontal second radiation arm 12, so that a vertical size of the main antenna 1 can be compressed, to adapt to a height of a shark fin of a vehicle or a height of a luggage rack of the vehicle.

Still refer to FIG. 4. The second radiation arm 12 includes a first inclined stub 121 and a horizontal stub 122. Both “inclined” and “horizontal” are relative to the mainboard 3. A plane on which the mainboard 3 is located is a horizontal plane. Such a design of the second radiation arm 12 can not only shorten a horizontal size of the main antenna 1 to make the main antenna more compact, but also adjust a position relationship between the tail end of the main antenna 1 and the middle position of the parasitic antenna 2, so that the tail end of the main antenna 1 is close to the middle position of the parasitic antenna 2.

Still refer to FIG. 4. The first radiation arm 11 includes a first stub 111 and a second stub 112. One end of the first stub 111 is vertically located on the surface of the mainboard 3, and the other end is connected to one end of the second stub 112. The other end of the second stub 112 is vertically connected to the second radiation arm 12. As shown in FIG. 4, a width of the second stub 112 is greater than a width of the first stub 111.

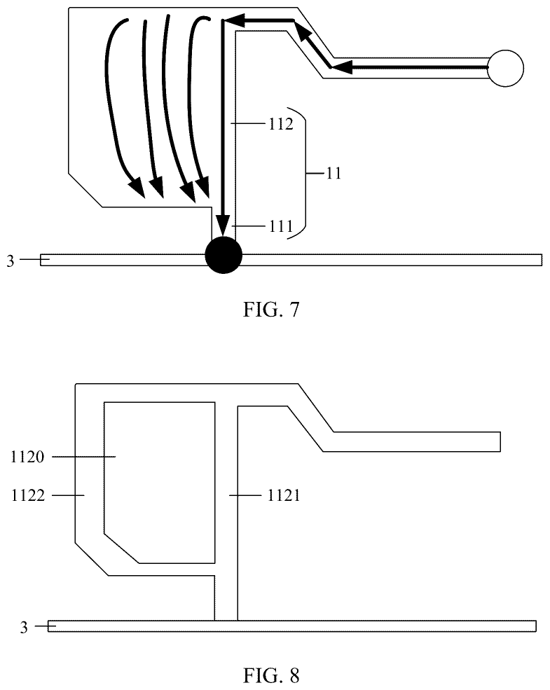

As shown in FIG. 7, the second stub 112 is wide, and there are a plurality of current paths distributed on the second stub 112. Although electrical lengths corresponding to these current paths are similar, the electrical lengths are slightly different. Different electrical lengths excite different resonance frequencies. Therefore, a plurality of different electrical lengths excite a plurality of resonance frequencies that are close but different, thereby helping expand a bandwidth of the antenna.

Because the second stub 112 is wide, the second stub 112 may be hollowed out, so that the second stub 112 forms a ring shown in FIG. 8, including a hollow area 1120 and a first branch 1121 and a second branch 1122 that are located on left and right sides of the hollow area 1120.

As shown in FIG. 8, the second stub 112 includes the first branch 1121 and the second branch 1122 that are independent of each other. In this case, a current distributed on the first branch 1121 can excite an electromagnetic wave of a resonance frequency, and a current distributed on the second branch 1122 can excite an electromagnetic wave of another resonance frequency, so that a quantity of resonance frequencies of the antenna can be increased, and a bandwidth of the antenna can be expanded by increasing the quantity of resonance frequencies.

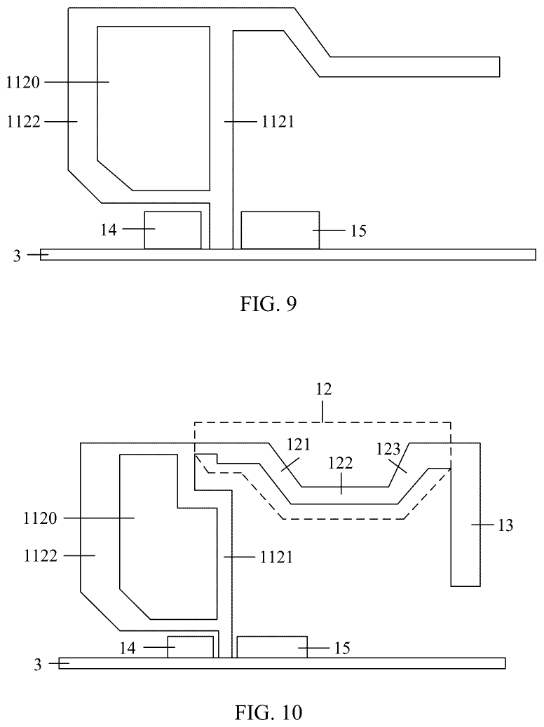

As shown in FIG. 9, the main antenna 1 may further include a first matching stub 14. As shown in FIG. 9, because the second stub 112 is wider than the first stub 111, there is a specific spacing between the second stub 112 and the mainboard 3. The first matching stub 14 may be located in the spacing. For example, the first matching stub 14 is fastened to the mainboard 3, is located on a side of the first stub 111, and is between the second stub 112 and the mainboard 3.

In this way, a capacitor can be formed between edges that are of the first matching stub 14 and the first stub 111 and that are close to each other, and/or between the edges that are of the first matching stub 14 and the second stub 112 and that are close to each other. The formed capacitor can be used to adjust impedance matching between the antenna and the feeder, to reduce a return loss and improve radiation efficiency of the antenna.

For example, the antenna may be a full frequency antenna, and can receive and send electromagnetic waves in a low frequency band, a medium-high frequency band, and a high frequency band. The first matching stub 14 can be used to adjust an impedance matching feature of the medium-high frequency, and reduce a return loss of the medium-high frequency.

Still refer to FIG. 9. The main antenna 1 may further include a second matching stub 15. The second matching stub 15 is fastened to the surface of the mainboard 3, and the second matching stub 15 is located on a side that is of the first stub 111 and that is opposite to a location of the first matching stub 14. In other words, the first stub 111 is located between the first matching stub 14 and the second matching stub 15. As shown in FIG. 9, a capacitor can also be formed between edges that are of the second matching stub 15 and the first stub 111 and that are close to each other. In this case, the second matching stub 15 may also be configured to adjust an impedance matching feature between the main antenna 1 and the feeder.

In an example, the first matching stub 14 and the second matching stub 15 may be integrated and processed. For example, a metal plate on which the first matching stub 14 and the second matching stub 15 are located has an opening, and the opening divides the metal plate into the first matching stub 14 and the second matching stub 15. The first stub 111 passes through the opening and is fastened to the surface of the mainboard 3.

In another example, the first matching stub 14 and the second matching stub 15 may also be two metal plates that are independent of each other.

In an example, the main antenna 1 may adjust the impedance matching feature with the feeder through the first matching stub 14, or may adjust the impedance matching feature with the feeder through the second matching stub 15, or may adjust the impedance matching feature with the feeder through the first matching stub 14 and the second matching stub 15. This is not limited in embodiments.

As described above, one end of the first radiation arm 11 is vertically located on the surface of the mainboard 3, and the other end is vertically connected to one end of the second radiation arm 12. As shown in FIG. 10, the main antenna 1 may further include a third radiation arm 13, one end of the third radiation arm 13 is vertically connected to the other end of the second radiation arm 12, and the other end of the third radiation arm 13 is an open end (that is, a tail end) of the main antenna 1.

As shown in FIG. 10, the third radiation arm 13 is vertically disposed relative to the mainboard 3, to further shorten a horizontal size of the main antenna 1, and further make the main antenna 1 more compact.

Still refer to FIG. 10. In addition to the first inclined stub 121 and the horizontal stub 122, the second radiation arm 12 may further include a second inclined stub 123, where the first inclined stub 121, the horizontal stub 122, and the second inclined stub 123 are sequentially connected. The second radiation arm 12 includes a structural feature of the first inclined stub 121, the horizontal stub 122, and the second inclined stub 123 that are sequentially connected, so that a horizontal size of the main antenna 1 can be further compressed, and a structure of the main antenna 1 can be further compact.

(2) Structural feature of the parasitic antenna 2.

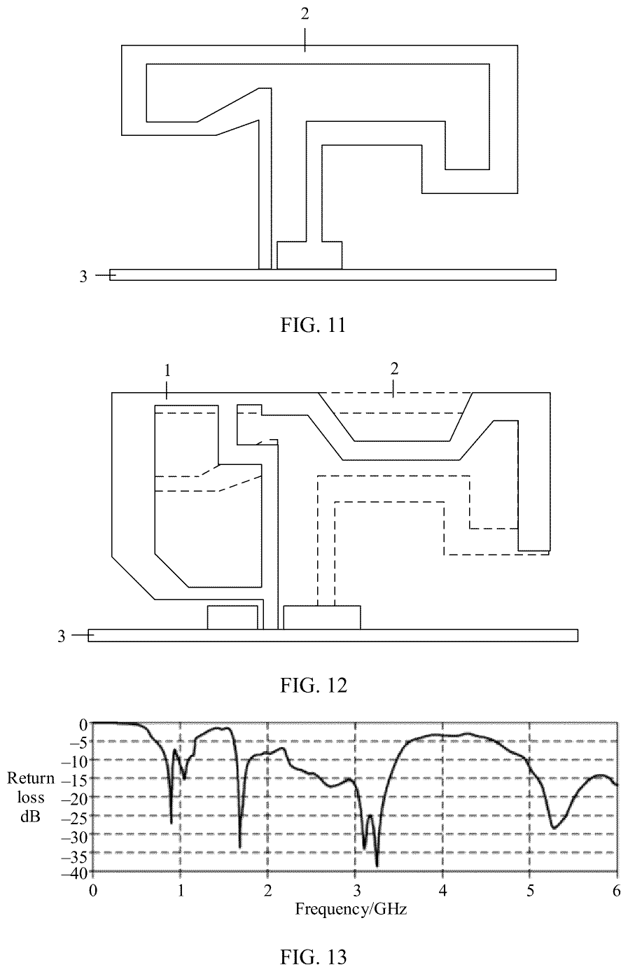

As shown in FIG. 5 and FIG. 11, the parasitic antenna 2 is a polygonal ring formed by multi-edge connection. A ring-shaped disposing manner of the parasitic antenna 2 is mainly to adapt to the main antenna 1. For example, as shown in FIG. 6 and FIG. 12, the disposing manner is to implement that a width of the parasitic antenna 2 is equal to or close to a width of the main antenna 1, and a height of the parasitic antenna 2 is equal to or close to a height of the main antenna 1. For another example, the disposing manner is to implement that the tail end of the main antenna 1 and the middle position of the parasitic antenna 2 are also close. For another example, the disposing manner is to implement that the start end of the main antenna 1 and the first end of the parasitic antenna 2 are also close.

To distinguish the main antenna 1 from the parasitic antenna 2, a solid line in FIG. 12 represents the main antenna 1, and a dashed line represents the parasitic antenna 2.

In an example, as shown in FIG. 11, a width of the second end of the parasitic antenna 2 is expanded. The expanding design means that the width of the second end is greater than a width of another position. The expanding design is similar to adding an inductor, and can be used to adjust an impedance matching feature between the antenna and the feeder, thereby reducing a return loss.

(3) Simulation result of an antenna shown in FIG. 12.

In an example, simulation is performed on the antenna shown in FIG. 12, to obtain feature diagrams shown in FIG. 13 to FIG. 15.

FIG. 13 is a diagram of a return loss feature. In FIG. 13, a vertical coordinate represents a return loss, 0 dB represents a maximum return loss, and an impedance matching feature between an antenna and a feeder is the worst. Negative infinity represents a minimum return loss, and the impedance matching feature between the antenna and the feeder is the best. A horizontal coordinate in FIG. 13 represents a frequency.

As shown in FIG. 13, a return loss of the antenna in low frequency bands whose frequency band numbers are respectively N28, B5, and B8 is less than −5 dB, a return loss of the antenna in medium-high frequency bands whose frequency band numbers are respectively B3, B34, B39, B40, and B41 is also less than −5 dB, and a return loss of the antenna in a high frequency band whose frequency band number is N79 is also less than −5 dB. Therefore, the antenna can implement 4G and 5G wideband coverage.

An uplink frequency band of N28 is 703 MHz to 748 MHz, and a downlink frequency band is 758 MHz to 803 MHz. An uplink frequency band of B5 is 824 MHz to 849 MHz, and a downlink frequency band is 869 MHz to 894 MHz. An uplink frequency band of B8 is 880 MHz to 915 MHz, and a downlink frequency band is 925 MHz to 960 MHz. An uplink frequency band of B3 is 1710 MHz to 1785 MHz, and a downlink frequency band is 1805 MHz to 1880 MHz. Uplink and downlink frequency bands of B34 are both 2010 MHz to 2025 MHz. Uplink and downlink frequency bands of B39 are both 1880 MHz to 1920 MHz. Uplink and downlink frequency bands of B41 are both 2496 MHz to 2690 MHz. Uplink and downlink frequency bands of N79 are both 4800 MHz to 5000 MHz.

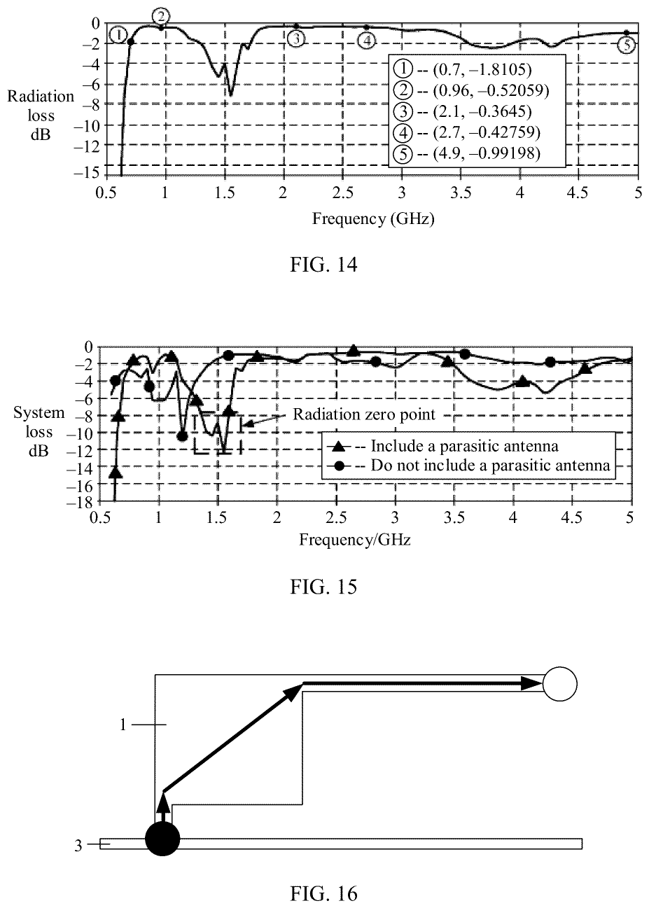

FIG. 14 is a diagram of an antenna radiation efficiency feature. A vertical coordinate in FIG. 14 represents a radiation efficiency los, 0 dB represents no loss, corresponds to radiation efficiency 1, and −3 dB may correspond to radiation efficiency of 50%. Negative infinity indicates that the radiation loss is the largest and the radiation efficiency is the lowest. A horizontal coordinate in FIG. 14 represents a frequency.

FIG. 15 is a diagram of a system efficiency feature. Meanings represented by FIG. 15 and FIG. 14 are similar, but FIG. 15 is an efficiency state of an entire system, including efficiency caused by a return loss and radiation efficiency. In this case, a vertical coordinate in FIG. 15 represents a system efficiency loss, 0 dB represents no loss, corresponds to system efficiency 1, and −3 dB may correspond to radiation efficiency of 50%. Negative infinity indicates that the radiation loss is the largest and the system efficiency is the lowest. A horizontal coordinate in FIG. 15 represents a frequency.

As shown in FIG. 14 and FIG. 15, in-band radiation efficiency of the antenna in the 5G frequency band is greater than-2 dB.

According to, in FIG. 14 and FIG. 15, a smaller number on the vertical coordinate indicates a larger loss and lower efficiency. Therefore, in the efficiency feature diagram, a minimum value point corresponds to a radiation zero point. Therefore, as shown in FIG. 14 and FIG. 15, in comparison with a conventional antenna that does not include a parasitic antenna, the antenna provided in this embodiment has a radiation zero point located outside a band, and therefore has a good anti-inter-frequency interference feature.

A position of the radiation zero point may be adjusted by adjusting a coupling degree between the main antenna 1 and the parasitic antenna 2. For example, the radiation zero point may be adjusted to a frequency band of a global navigation satellite system (GNSS) antenna, to reduce interference of the GNSS antenna to a B8 frequency band and a B3 frequency band in the 5G frequency band.

In this way, even if the communication antenna shown in this embodiment and the GNSS antenna are disposed together, interference of the GNSS antenna to the communication antenna can be reduced.

Therefore, the antenna shown in FIG. 12 can effectively expand a frequency band of the antenna, and implement 4G and 5G full bandwidth coverage. On this basis, an out-of-band suppression degree and an anti-inter-frequency interference feature are improved.

The foregoing describes a structural feature and simulation effect that the main antenna 1 is a monopole antenna and the parasitic antenna 2 is a ring antenna. The following describes a structural feature and simulation effect that the main antenna 1 is a monopole antenna and the parasitic antenna 2 is also a monopole antenna.

(2) The main antenna 1 is the monopole antenna, and the parasitic antenna 2 is also the monopole antenna.

FIG. 16 is a diagram of a structure of a main antenna 1. Refer to the foregoing description. A current strong point position of the main antenna 1 is a start end, and a current weak point position is a tail end.

FIG. 17 is a diagram of a structure of a parasitic antenna 2. One end of the parasitic antenna 2 is fastened to a surface of a mainboard 3, and is electrically connected to the mainboard 3 to be grounded. The other end of the parasitic antenna 2 is open, and the parasitic antenna 2 is a monopole antenna. In this case, as described above, the end fastened to the mainboard 3 is denoted as a start end, and the open end is denoted as a tail end. A current strong point position of the parasitic antenna 2 is the start end, and a current weak point position is the tail end.

An arrow in FIG. 16 and FIG. 17 indicates distribution of a current on the main antenna 1 at a moment. FIG. 16 is current distribution of a ¼ wavelength line mode excited by the main antenna 1, and FIG. 17 is current distribution of a ¼ wavelength line mode excited by the parasitic antenna 2.

Therefore, when the coupling degree between the main antenna 1 and the parasitic antenna 2 is adjusted, a position relationship between the start end of the main antenna 1 and the start end of the parasitic antenna 2 may be adjusted, and a position relationship between the tail end of the main antenna 1 and the tail end of the parasitic antenna 2 may be adjusted, so that the antenna obtained by coupling between the main antenna 1 and the parasitic antenna 2 includes a plurality of resonance modes, to expand a coverage bandwidth of the antenna.

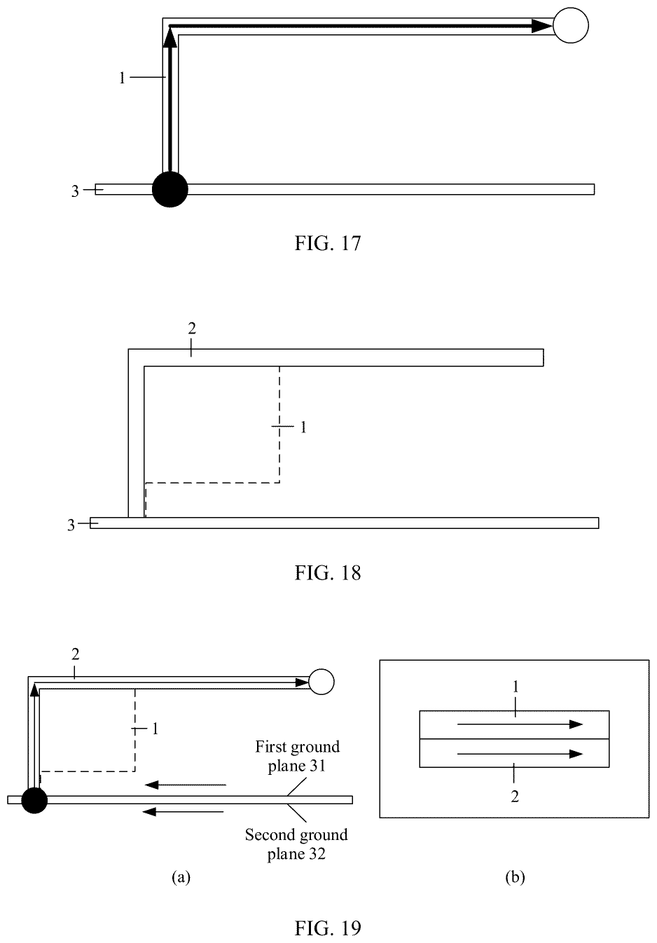

In an example, a position relationship between the start end of the main antenna 1 and the start end of the parasitic antenna 2 is adjusted. For example, a distance between the start end of the main antenna 1 and the start end of the parasitic antenna 2 is less than a third value, so that the start end of the main antenna 1 and the start end of the parasitic antenna 2 are close, as shown in FIG. 18.

Similarly, a position relationship between the tail end of the main antenna 1 and the tail end of the parasitic antenna 2 is adjusted. For example, a distance between the tail end of the main antenna 1 and the tail end of the parasitic antenna 2 is less than a fourth value, so that the tail end of the main antenna 1 and the tail end of the parasitic antenna 2 are close, as shown in FIG. 18.

The third value and the fourth value may be determined by using a simulation result. In addition, the main antenna 1 and the parasitic antenna 2 are located in different resonance frequency bands. Therefore, values of the third value and the fourth value are also different. For example, if frequency bands of the resonance frequency points of the main antenna 1 and the parasitic antenna 2 are both low frequency bands (700 MHz to 960 MHz), the third value may be 8 mm, and the fourth value may be 25 mm.

The foregoing distances are all space distances in three-dimensional space.

The foregoing is about a disposing position relationship between the main antenna 1 and the parasitic antenna 2. For a structural feature of the main antenna 1, because both the main antenna 1 described in (2) and the main antenna 1 described in (1) are monopole antennas, for the structural feature of the main antenna 1 described in (2), refer to the foregoing (1). Details are not described herein again.

For the structural feature of the parasitic antenna 2, as shown in FIG. 17, the parasitic antenna 2 also includes a vertical stub and a horizontal stub, to match the main antenna 1. The main antenna 1 matches the parasitic antenna 2. For example, as shown in FIG. 18, a width of the main antenna 1 is equivalent to a width of the parasitic antenna, a height of the main antenna 1 is equivalent to a height of the parasitic antenna 2, the start end of the main antenna 1 is close to the start end of the parasitic antenna 2, and the tail end of the main antenna 1 is close to the tail end of the parasitic antenna 2.

For the antenna shown in FIG. 18, after the main antenna 1 and the parasitic antenna 2 are coupled to each other, current distribution shown in FIG. 19 to FIG. 21 can be generated. (a) in FIG. 19 is a front view, and (b) is a top view. As shown in (b) in FIG. 19, current directions on the main antenna 1 and the parasitic antenna 2 are the same, and the two current directions are superimposed. As shown in (a) in FIG. 19, currents distributed on the first ground plane 31 and the second ground plane 32 of the mainboard 3 are also in a same direction. In this case, as shown in current distribution in FIG. 19, an excited resonance mode is an effective resonance mode generated by electromagnetic coupling. The resonance mode may be denoted as a resonance mode 1 of the antenna, and a corresponding resonance point is denoted as a resonance point 1.

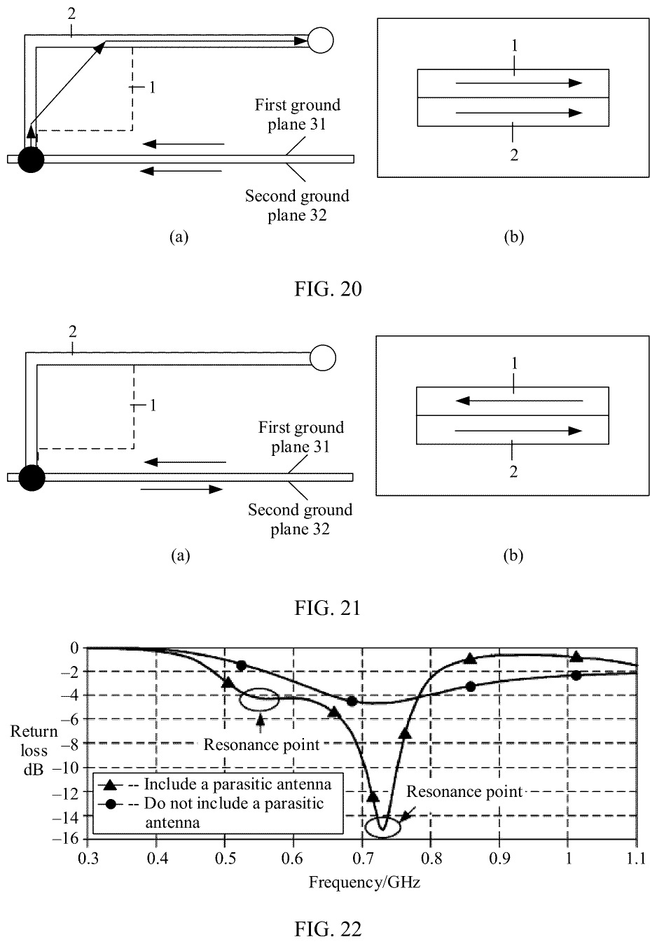

(a) in FIG. 20 is a front view, and (b) is a top view. As shown in (b) in FIG. 20, current directions on the main antenna 1 and the parasitic antenna 2 are the same, and the two current directions superimposed. As shown in (a) in FIG. 20, currents distributed on the first ground plane 31 and the second ground plane 32 of the mainboard 3 are also in a same direction. In this case, as shown in current distribution in FIG. 20, an excited resonance mode is an effective resonance mode generated by electromagnetic coupling. The resonance mode may be denoted as a resonance mode 2 of the antenna, and a corresponding resonance point is denoted as a resonance point 2.

(a) in FIG. 21 is a front view, and (b) is a top view. As shown in (b) in FIG. 21, a current direction on the main antenna 1 is opposite to a current direction on the parasitic antenna 2, and the two current directions cancel each other. As shown in (a) in FIG. 21, currents distributed on the first ground plane 31 and the second ground plane 32 of the mainboard 3 are also reverse. In this case, as shown in current distribution in FIG. 21, an excited resonance mode has low radiation efficiency, and is an invalid resonance mode generated by electromagnetic coupling. The resonance mode may be denoted as a resonance mode 3 of the antenna, and a corresponding resonance point is denoted as a resonance point 3.

In an example, the resonance mode 3 may be eliminated by co-grounding the main antenna 1 and the parasitic antenna 2. The main antenna 1 and the parasitic antenna 2 are co-grounded. In other words, an outer conductor of a feeder connected to the main antenna 1 is co-grounded with the parasitic antenna 2. For a co-grounding solution, refer to the foregoing description. Details are not described herein again.

In an example, if the resonance point 3 corresponding to the resonance mode 3 is close to the resonance point 2 corresponding to the resonance mode 2, after the invalid resonance mode 3 is eliminated, a decrease rate of the radiation loss of the resonance mode 2 can be further reduced. This is because the resonance mode 3 is invalid resonance, and a radiation loss at the resonance point 3 is large. In the diagram of the radiation efficiency feature, the resonance point 3 corresponds to a minimum value point. If the resonance mode 3 is not eliminated, in the diagram of the radiation efficiency feature, the radiation loss decreases rapidly from the resonance point 2 to the resonance point 3. In this case, the radiation efficiency of the antenna decreases rapidly from the resonance point 2 to the resonance point 3. If the resonance mode 3 is eliminated, because the resonance point 3 is not a corresponding minimum value point in the diagram of the radiation efficiency feature, the radiation loss does not decrease rapidly from the resonance point 2 to the resonance point 3. Therefore, the invalid resonance mode 3 is eliminated, so that a decrease rate of the radiation loss of the resonance mode 2 can be reduced.

It should be noted that, for the antenna shown in FIG. 12, current distribution on the main antenna 1 and the parasitic antenna 2 can also excite a plurality of resonance modes. In the plurality of resonance modes, there may also be an invalid resonance mode. In this case, the invalid resonance mode may also be eliminated by co-grounding the main antenna 1 and the parasitic antenna 2.

The following describes a simulation result of the antenna shown in FIG. 18.

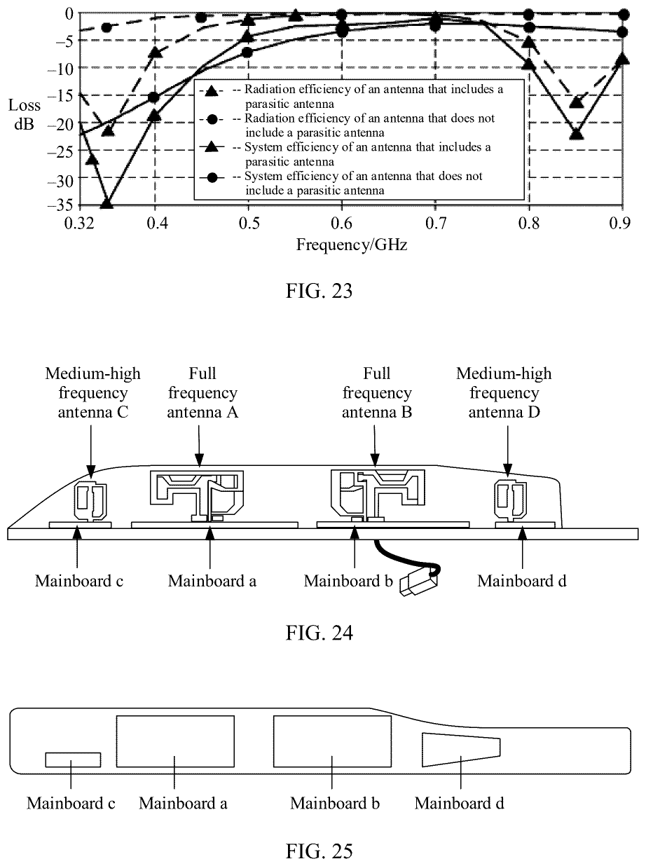

In an example, simulation is performed on the antenna shown in FIG. 18, to obtain feature diagrams shown in FIG. 22 and FIG. 23.

FIG. 22 is a diagram of a return loss feature. A vertical coordinate in FIG. 22 represents a return loss, 0 dB represents a maximum return loss, and an impedance matching feature between an antenna and a feeder is the worst. Negative infinity represents a minimum return loss, and the impedance matching feature between the antenna and the feeder is the best. A horizontal coordinate in FIG. 22 represents a frequency.

According to FIG. 22, a smaller number on the vertical coordinate indicates a smaller return loss. Therefore, in the diagram of the return feature, a minimum value point corresponds to a resonance point. Therefore, as shown in FIG. 22, in comparison with a conventional antenna that does not include a parasitic antenna, the antenna provided in this embodiment includes two resonance points, so that a bandwidth of the antenna can be expanded. Positions of the two resonance points may be adjusted by adjusting coupling strength between the main antenna 1 and the parasitic antenna 2.

FIG. 23 is a diagram of an efficiency feature. A vertical coordinate in FIG. 23 represents an efficiency loss, 0 dB represents no loss, and corresponds to efficiency of 1, and −3 dB may correspond to efficiency of 50%. Negative infinity indicates that the loss is the largest and the efficiency is the lowest. A horizontal coordinate in FIG. 23 represents a frequency. A dashed line in FIG. 23 represents a change relationship between the radiation efficiency and the frequency, and a solid line represents a change relationship between system efficiency and the frequency.

In FIG. 23, a smaller number on the vertical coordinate indicates a larger loss and lower efficiency. Therefore, in the diagram of the efficiency feature, a minimum value point corresponds to a radiation zero point. Therefore, as shown in FIG. 23, in comparison with a conventional antenna that does not include a parasitic antenna, the antenna provided in this embodiment has the radiation zero point (the minimum value point in FIG. 23 is the radiation zero point), and therefore has a good anti-inter-frequency interference feature.

The antenna including the parasitic antenna is the antenna provided in this embodiment, and the antenna not including the parasitic antenna may be a conventional antenna that includes only the main antenna and does not include the parasitic antenna.

A position of the radiation zero point may be adjusted by adjusting a coupling degree between the main antenna 1 and the parasitic antenna 2. For example, the radiation zero point may be adjusted to a frequency band of a global navigation satellite system (GNSS) antenna, to reduce interference of the GNSS antenna to a B8 frequency band and a B3 frequency band in a 5G frequency band.

In this way, even if the communication antenna shown in this embodiment and the GNSS antenna are disposed together, interference of the GNSS antenna to the communication antenna can be reduced.

Therefore, the antenna shown in FIG. 18 can effectively expand the frequency band of the antenna, and implement 4G and 5G full bandwidth coverage. On this basis, an out-of-band suppression degree and an anti-inter-frequency interference feature are improved.

In this embodiment of this disclosure, the antenna includes a main antenna and a parasitic antenna. The main antenna and the parasitic antenna are disposed at opposite positions. An excitation signal of the main antenna is introduced through a feeder, and an excitation signal of the parasitic antenna is introduced through an electromagnetic field coupled to the main antenna. The main antenna and the parasitic antenna are coupled to each other, so that a bandwidth of the antenna can be expanded. In this case, the antenna is used in a vehicle as a communication antenna of the vehicle, for example, a 4G communication antenna or a 5G communication antenna, to implement 4G or 5G wide bandwidth coverage, or even full bandwidth coverage.

In addition, the antenna can further improve an out-of-band suppression degree and improve an anti-inter-frequency interference feature. For example, the antenna can improve an out-of-band suppression degree of a GNSS antenna, so that even if the GNSS antenna and the antenna in this embodiment are disposed together, for example, both are disposed on a shark fin or both are disposed in a luggage rack, interference of the GNSS antenna to the antenna in this embodiment can be reduced.

An embodiment of this disclosure further provides an antenna system. The antenna system includes a radio frequency circuit and the foregoing antenna. The radio frequency circuit is configured to receive and send a radio signal through the antenna.

An embodiment of this disclosure further provides a vehicle, where the vehicle includes the foregoing antenna system.

The following describes a disposing position of an antenna in the antenna system in the vehicle.

In an example, the antenna of the antenna system may be disposed in a luggage rack of the vehicle. For example, the vehicle includes a left luggage rack located on a left side of the vehicle body and a right luggage rack located on a right side of the vehicle body. The antenna may be disposed in the left luggage rack, or may be disposed in the right luggage rack, or may be disposed in both the left luggage rack and the right luggage rack.

For example, as shown in FIG. 24, an antenna architecture disposed in the luggage rack is a 4×4 multiple-input multiple-output (MIMO) system, and includes two 5G full frequency antennas and two 5G medium-high frequency antennas. The four antennas are respectively denoted as a full frequency antenna A, a full frequency antenna B, a medium-high frequency antenna C, and a medium-high frequency band antenna D. Because the full frequency antenna has a large size, the full frequency antenna A and the full frequency antenna B are located at a high position of a section of the luggage rack, and the medium-high frequency antenna C and the medium-high frequency band antenna D are located at a low position of the section of the luggage rack.

The full frequency antenna A and the full frequency antenna B may use the antenna provided in this embodiment, for example, may use the antenna shown in FIG. 12.

As shown in FIG. 25, a mainboard a of the full frequency antenna A, a mainboard b of the full frequency antenna B, a mainboard c of the medium-high frequency antenna C, and a mainboard d of the medium-high frequency antenna D are all fastened to a surface of a metal base of the luggage rack.

In an example, components such as a feeding coplanar waveguide transmission line, a series position matching component, a parallel position matching component, and a series position detection resistor are printed on the mainboard. An excitation signal of the antenna is fed through a mini-fakra four-in-one connector, and then is transmitted to the four mainboards through a vehicle body harness. Finally, the excitation signal is transmitted to the four antennas through a coplanar waveguide transmission line on each mainboard, and the four antennas radiate electromagnetic waves to free space.

Certainly, in another example, the antenna may also be disposed in a shark fin of the vehicle. For example, the four antennas are all disposed in the shark fin.

The following describes a disposing position of a radio frequency circuit in the antenna system in the vehicle.

In an example, the radio frequency circuit of the antenna system may be disposed in a telematics box (T-BOX) of the vehicle.

To reduce a path loss of a radio frequency signal on a transmission path, correspondingly, the T-BOX in which the radio frequency circuit is located and an antenna are as close as possible. For example, the T-BOX is located on a rear seat, and is close to a tail that is of the vehicle and that is close to a tire, and the antenna is located in the luggage rack of the vehicle. In this case, the luggage rack in which the antenna is located and the T-BOX are located on a same side of the vehicle body.

In an example, the antenna is located in the right luggage rack on the right side of the vehicle body, and the T-BOX in which the radio frequency circuit is located is located on a rear seat, and is close to a tail that is of the vehicle and that is close to a tire.

In this way, when the vehicle supplies power to the T-BOX, the radio frequency signal generated by the radio frequency circuit in the T-BOX is transmitted to a mainboard on the roof the vehicle through a signal cable, to excite the antenna, so that the antenna radiate a modulation signal to free space. For the receive link, the reverse is also true.

The T-BOX is located on a rear seat, and is close to a tail that is of the vehicle and that is close to a tire. In addition, the luggage rack in which the antenna is located and the T-BOX are located on a same side of the vehicle body, so that a space distance between the antenna and the T-BOX is short. In this case, a harness of a signal cable is short. This can effectively reduce a link loss caused by a cable, thereby improving system efficiency of an entire vehicle antenna.

In addition, the antenna is hidden in the luggage rack structure, and a housing of the luggage rack is made by using a melting and casting process. A waterproof rubber pad is disposed between the luggage rack and the metal base at the top of the vehicle body, thereby ensuring concealment and reliability of the vehicle antenna.

The foregoing descriptions are merely an embodiment of this disclosure, but are not intended to limit this disclosure. Any modification, equivalent replacement, or improvement made without departing from the principle of this disclosure shall fall within the protection scope of this disclosure.

What is claimed is:

1. An antenna, wherein the antenna comprises a main antenna (1), a parasitic antenna (2), and a mainboard (3);
the main antenna (1) and the parasitic antenna (2) are both located on a surface of the mainboard (3), and a plane on which the main antenna (1) is located and a plane on which the parasitic antenna (2) is located are parallel, and are opposite to each other;
a feeding point of the main antenna (1) is connected to a feeding transmission line of the mainboard (3), and the parasitic antenna (2) is connected to a second ground end of the mainboard (3); and
a difference between a resonance frequency point of the main antenna (1) and a resonance frequency point of the parasitic antenna (2) is less than a target threshold.

2. The antenna according to claim 1, wherein the feeding point of the main antenna (1) is connected to an inner conductor of the feeding transmission line of the mainboard (3), an outer conductor of the feeding transmission line is connected to a first ground end of the mainboard (3), and the first ground end and the second ground end are co-grounded.

3. The antenna according to claim 1, wherein the main antenna (1) is a monopole antenna, and the parasitic antenna (2) is a ring antenna.

4. The antenna according to claim 3, wherein a start end of the main antenna (1) is the feeding point, and both ends of the parasitic antenna (2) are connected to the second ground end of the mainboard (3); and
a distance between the start end of the main antenna (1) and an end part of the parasitic antenna (2) is less than a first value, and a distance between a tail end of the main antenna (1) and a middle position of the parasitic antenna (2) is less than a second value.

5. The antenna according to claim 1, wherein the main antenna (1) is a monopole antenna, and the parasitic antenna (2) is a monopole antenna.

6. The antenna according to claim 5, wherein a start end of the main antenna (1) is the feeding point, and a start end of the parasitic antenna is connected to the second ground end of the mainboard (3); and
a distance between the start end of the main antenna (1) and the start end of the parasitic antenna (2) is less than a third value, and a distance between a tail end of the main antenna (1) and a tail end of the parasitic antenna (2) is less than a fourth value.

7. The antenna according to claim 1, wherein the main antenna (1) is a ring antenna, and the parasitic antenna (2) is a ring antenna or a monopole antenna.

8. The antenna according to claim 1, wherein the main antenna (1) comprises a first stub (111) and a second stub (112); and
one end of the first stub (111) is vertically located on the surface of the mainboard (3), the other end is connected to the second stub (112), and a width of the second stub (112) is greater than a width of the first stub (111).

9. The antenna according to claim 8, wherein the main antenna (1) further comprises a first matching stub (14);
there is a spacing between the second stub (112) and the mainboard (3), and the first matching stub (14) is fastened to the mainboard (3), is located on one side of the first stub (111), and is located between the second stub (112) and the mainboard (3); and
edges that are of the first matching stub (14) and the first stub (111) and that are close to each other, and/or edges that are of the first matching stub (14) and the second stub (112) and that are close to each other are all configured to form a capacitor.

10. The antenna according to claim 8, wherein the second stub (112) comprises a first branch (1121) and a second branch (1122), and the first branch (1121) and the second branch (1122) are disposed side by side in a width direction of the second stub (112); and
one end of the first branch (1121) is connected to one end of the second branch (1122), and the other end of the first branch (1121) and the other end of the second branch (1122) are both connected to the first stub (111).

11. The antenna according to claim 1, wherein the main antenna (1) comprises a first radiation arm (11), a second radiation arm (12), and a third radiation arm (13); and
one end of the first radiation arm (11) is vertically located on the surface of the mainboard (3), the other end is vertically connected to one end of the second radiation arm (12), and the other end of the second radiation arm (12) is vertically connected to one end of the third radiation arm (13).

12. The antenna according to claim 1, wherein a total height of the main antenna (1) is equal to a total height of the parasitic antenna (2), and a total width of the main antenna (1) is equal to a total width of the parasitic antenna (2).

13. The antenna according to claim 1, wherein the antenna further comprises a dielectric plate, the dielectric plate is vertically located on the surface of the mainboard (3), the main antenna (1) is located on a first surface of the dielectric plate, the parasitic antenna (2) is located on a second surface of the dielectric plate, and the first surface and the second surface of the dielectric plate are opposite to each other.

14. An antenna system, wherein the antenna system comprises:
an antenna, and
a radio frequency circuit configured to receive and send a radio signal through the antenna;
wherein the antenna comprises a main antenna (1), a parasitic antenna (2), and a mainboard (3);
the main antenna (1) and the parasitic antenna (2) are both located on a surface of the mainboard (3), and a plane on which the main antenna (1) is located and a plane on which the parasitic antenna (2) is located are parallel, and are opposite to each other;
a feeding point of the main antenna (1) is connected to a feeding transmission line of the mainboard (3), and the parasitic antenna (2) is connected to a second ground end of the mainboard (3); and
a difference between a resonance frequency point of the main antenna (1) and a resonance frequency point of the parasitic antenna (2) is less than a target threshold.

15. A vehicle, wherein the vehicle comprises:
an antenna; and
a radio frequency circuit configured to receive and send a radio signal through the antenna;
wherein the antenna comprises a main antenna (1), a parasitic antenna (2), and a mainboard (3);
the main antenna (1) and the parasitic antenna (2) are both located on a surface of the mainboard (3), and a plane on which the main antenna (1) is located and a plane on which the parasitic antenna (2) is located are parallel, and are opposite to each other;
a feeding point of the main antenna (1) is connected to a feeding transmission line of the mainboard (3), and the parasitic antenna (2) is connected to a second ground end of the mainboard (3); and
a difference between a resonance frequency point of the main antenna (1) and a resonance frequency point of the parasitic antenna (2) is less than a target threshold.

16. The vehicle according to claim 15, wherein the antenna is located in a luggage rack of the vehicle.

17. The vehicle according to claim 16, wherein the radio frequency circuit is disposed in a telematics box T-BOX of the vehicle, the T-BOX is located on a rear seat, and is close to a tail that is of the vehicle and that is close to a tire, and the luggage rack in which the antenna is located and the T-BOX are located on a same side of a vehicle body of the vehicle.

18. The vehicle according to claim 15, wherein the antenna is located in a shark fin of the vehicle.
